(19) United States
(12) Patent Application Publication
(10) Pub. No.: US 2010/0026058 A1
(43) Pub. Date: Feb. 4, 2010

(54) Structure of saddle in particular for cycles, motorcycles and pedal machines

(75) Inventor: Massimo Losio, Asolo (IT)

Correspondence Address: Themis Law, 7660 Fay Ave Ste H-535, La Jolla, CA, 92037, US

(73) Assignee: SELLE ROYAL S.P.A., Pozzoleone (IT)

(21) Appl. No.: 11/917,345

(22) PCT Filed: Jun. 17, 2005
(86) PCT No.: PCT/IB05/01719

§ 371 Date: Dec. 26, 2007

(51) Int. Cl. B62J 1/20

(52) U.S. Cl. 297/214

(57) ABSTRACT

A saddle structure, particularly for bicycles, motorcycles and other pedal-operated machines comprises a main body (2) having predetermined elastic and surface properties, which defines a seat surface (3) for a user and means (4) for connecting the main body (2) to a frame of the machine. Particularly, the structure (1) has at least one secondary member (5) whose elastic and/or surface properties are different from those of the main body (2) and is equipped with releasable connection means (6), which allow to removably secure the member (5) to the main body (2), to define the seat surface (3).

### FIELD OF THE INVENTION

This invention generally finds application in the field of accessories for bicycles and motorcycles and particularly relates to a saddle structure as defined in the preamble of claim 1, for bicycles, motorcycles and pedal-operated machines.

### BACKGROUND ART

A number of saddles or similar structures for bicycles are known, which have differential rigidity portions for adequate distribution of pressure on the user.

Particularly, IT-A-VI2002A000208 discloses a saddle that comprises a yieldable pad and a rigid frame having one or more differential rigidity portions adapted to facilitate the pedaling motion.

The differential rigidity portions are positioned symmetrically along the edges of the saddle, on opposite sides of a longitudinal axis, in such a manner as to interact with the inside thighs of a user, or are located at a rear edge of the saddle.

A drawback of this arrangement is its poor flexibility, which is caused by the fact that the saddle has a fixed configuration, that may be inadequate or uncomfortable depending on how the saddle is used. Furthermore comfort perception is subjective and strongly influenced by the particular anatomic structure of the user. Therefore, the user shall adapt to the fixed configuration of the saddle, which causes a reduced comfort degree.

U.S. Pat. No. 5,904,396 discloses a saddle having one or more resilient inserts and a gel material to improve the distribution of contact pressure on the user. Unlike the previous example, the inserts are positioned inside the saddle. Nevertheless, this arrangement also has fixed inserts, and the configuration of the saddle cannot be adapted to different needs.

U.S. Pat. No. 5,330,249 and US-A-20020069464 disclose each a bicycle saddle which comprises a fixed support base defining a seat surface and a removable deformable cushion. Particularly, in U.S. Pat. No. 5,330,249 the deformable cushion is placed on the seat surface, whereas in the arrangement of US-a-20020069464, the deformable cushion has a pair of absorbent side portions and a central portion that lies on the support base to keep the side portions in position.

A drawback of these arrangements is that the configuration of the saddle is poorly adaptable to different needs. In fact, in the arrangement of the former document, the replacement of the deformable cushion can only involve a change of the overall resilience of the seat surface, whereas in the arrangement of the latter document, the deformable cushion only allows to adjust the side resilience of the saddle in the inside thigh areas of the user.

### SUMMARY OF THE INVENTION

A primary object of this invention is to obviate the above drawbacks, while providing a cost-effective saddle structure.

A particular object is to provide a saddle structure that can fit different user needs.

A further object of the invention is to provide a saddle structure that is comfortable and reduces the stresses exerted on the user, allowing an optimized distribution thereof.

Another particular object is to provide a saddle structure that is sturdy and reliable.

A further object of the invention is to provide a saddle structure that facilitates the control of the vehicle on which it is fitted.

These objects, as well as other objects that will be more apparent hereafter, are achieved, according to claim 1, by providing a saddle structure, particularly for bicycles, motorcycles and other pedal-operated machines, comprising a main body having predetermined elastic and surface properties, which defines a seat surface for a user and means for connecting the main body to a frame of the machine, characterized in that it comprises at least one secondary member whose elastic and/or surface properties are different from those of the main body, there being provided releasable connection means, for removably securing the member to the main body, so as to define the seat surface therewith.

Thanks to this particular configuration, the support structure may be easily adapted to various needs of a single user or different users.

### BRIEF DESCRIPTION OF THE DRAWINGS

Further characteristics and advantages of the invention will be more apparent from the detailed description of a few preferred, non-exclusive embodiments of a saddle structure according to the invention, which are described as non-limiting examples with the help of the annexed drawings, in which:

FIG. 1 is a general perspective view of the saddle structure according to the invention;

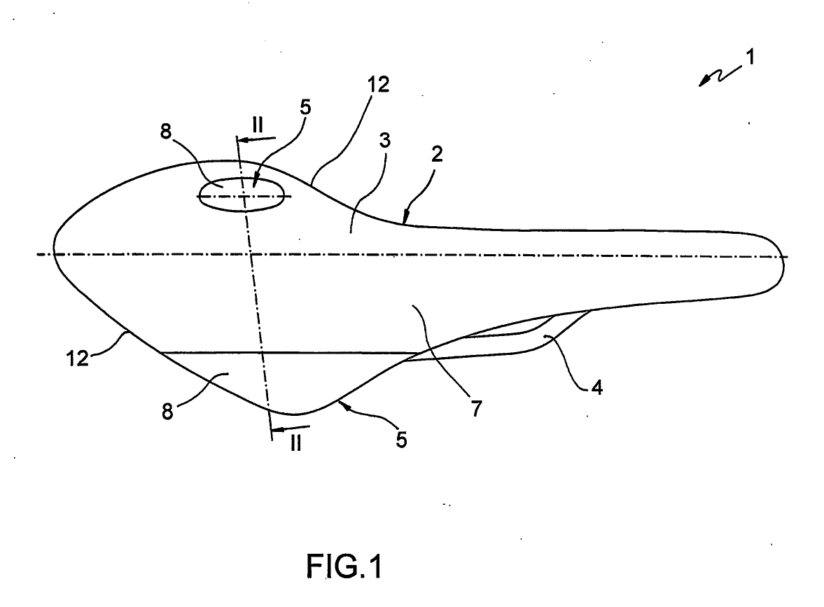

FIG. 2 is a sectional view taken along a transverse plane II-II of FIG. 1.

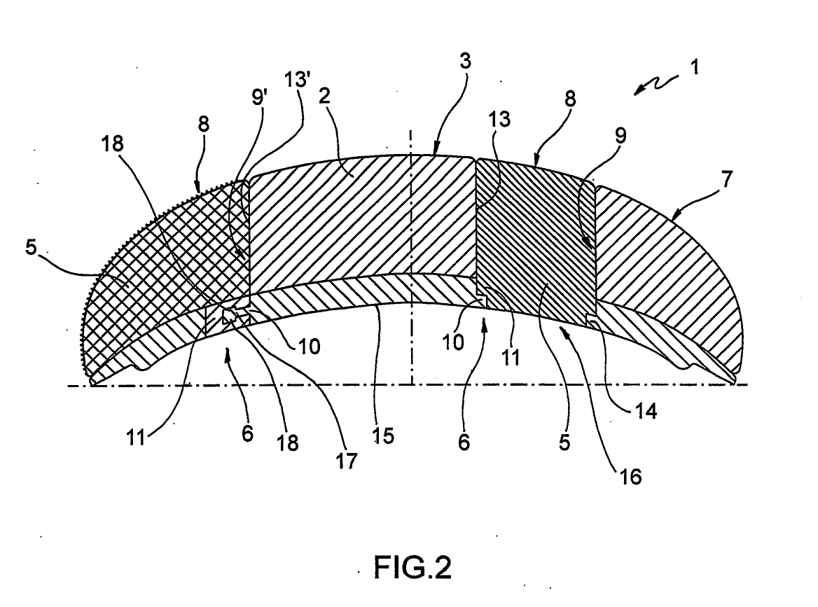

### DETAILED DESCRIPTION OF A PREFERRED EMBODIMENT

Particularly referring to the above figures, a saddle structure according to the invention is described, which is generally denoted by numeral 1, and is particularly designed for bicycles, motorcycles and other pedal-operated machines.

The structure 1 comprises a main body 2 which has predetermined elastic and surface properties, and defines a seat surface 3 for a user. Means 4 are further provided for connection of the main body 2 to a frame (not shown in the annexed drawings) of the machine.

One feature of the invention is that the structure 1 comprises at least one secondary support member 5, which may be removably secured to the main body 2 by releasable connection means 6, to define the seat surface 3 with such body 2. Furthermore, the secondary support member 5 has elastic and/or surface properties different from those of the main body 2.

There may be provided one secondary support member 5 only. In alternative embodiments, the structure 1 may comprise a plurality of secondary support members 5, which may be also removably secured to the main body 2 by respective releasable connection means 6.

The main body 2 and each secondary member 5 may have respective top surfaces 7, 8, connected together to form a substantially continuous seat surface 3 under the rider's weight. More in detail, the continuity of the seat surface 3 may be advantageously obtained by providing suitable housings 9, 9′ for the secondary members 5 in the main body 2. Each secondary member 5 may be inserted in a corresponding housing 9, 9′ so that its top surface 8 is substantially aligned with the top surface 7 of the main body 2.

The connection means 6 may be located at each housing 9, 9′ to suitably hold each secondary member 5 in the corresponding housing 9, 9′ while the structure 1 is being used. Particularly, the connection means 6 may include a first portion 10 integral with the main body 2 for each of the housings 9 and a second portion 11 integral with the corresponding secondary member 5, which is designed to interact with the first portion 10 to removably secure the corresponding secondary member 5.

To ensure an optimized fit between each secondary member 5 and the main body 2, the second portion 11 of the connection means 6 may have a different rigidity, particularly higher or lower than that of the member 5 integral therewith. Also, the second portion 11 may be made of one piece with the corresponding secondary member 5.

The housings 9, 9′ may be of various types and may be particularly formed inside the main body 2 or at an outer peripheral edge 12 of the main body 2.

Particularly, each housing 9 in the main body 2 may have a substantially concave wall at the interface with the corresponding secondary member 5. The wall 13 may also have a different shape and may particularly have a vertical orientation, as shown in the Figures, and an oval, elliptical or circular plan shape. Otherwise, the wall 13 may have an at least partially convex design, and possibly a plan shape other than the one described above.

Furthermore, the first portion 10 of the connection means 6 may have an edge 14 that projects out of the concave wall 13.

Such projecting edge 14 may be contoured to support the corresponding second portion 11 of the connection means 6 and may be provided inside the main body 2 or connected to a bottom wall 15 of the latter. Thanks to this arrangement, the projecting edge 14 allows to effectively hold the corresponding secondary member 5 while being substantially invisible from the outside, and helping to provide a structure 1 having a high aesthetic quality.

Advantageously, one or more housings 9 in the main body 2 may have a lower opening 16 at the bottom wall 15 of the main body 2, to facilitate removal of the corresponding secondary member 5.

As stated above, one or more housings 9′ may be located at the outer peripheral edge 12 of the main body 2. These peripheral housings 9′ may have an at least partially convex or plane wall 13′ at the interface with the corresponding secondary member 5. In this case, the first portion 10 of the connection means 6 may have an extension 17 projecting out of the at least partially convex wall 13′, for engagement in the corresponding second portion 11 of the connection means 6.

More in detail, the second portion 11 integral with a secondary member 5 may have one or more protuberances 18 for engagement with the projecting extension 17 integral with the main body 2, to prevent disconnection of the latter from the secondary member 5. The protuberances 18 may be provided in the form of appropriately spaced teeth along the outer peripheral edge 12 or may be substantially continuous therealong.

Regarding the housings 9′ located at the outer peripheral edge 12, the first and second portions 10, 11 may be covered by the corresponding secondary member 5 or be connected with the bottom wall 15 of the main body 2 to be substantially invisible from the outside.

The secondary members 5 may have different physical and surface properties so that any user may attach a desired secondary member 5 to the main body, depending on his/her anatomic structure or on how the machine is to be used. For example, a secondary member 5 having a lower rigidity than the main body 2 may be attached to a rear portion of the outer peripheral edge 12 when the user expects to ride difficult terrain, to facilitate control of a mountain-bike while not sitting on the saddle. Also, for improved customization, a secondary member 5 may have portions with different rigidities, and the top surface 8 of one or more secondary members 5 may have a surface roughness different from that of the top surface 7 of the main body 2.

The above disclosure clearly shows that the structure of the invention fulfils the proposed objects and particularly allows easy adaptation of shape, rigidity and surface roughness by replacing the secondary members. Furthermore, the latter allow to locally control the above properties in the areas of interest.

The structure of the invention is susceptible of a number of changes and variants, within the inventive concept disclosed in the appended claims. All the details thereof may be replaced by other technically equivalent parts, and the materials may vary depending on different needs, without departure from the scope of the invention.

While the structure has been described with particular reference to the accompanying figures, the numerals referred to in the disclosure and claims are only used for the sake of a better intelligibility of the invention and shall not be intended to limit the claimed scope in any manner.

1. A saddle structure, particularly for bicycles, motorcycles and other pedal-operated machines, comprising a main body (2) having predetermined elastic and surface properties, which defines a seat surface (3) for a user and means (4) for connecting said main body (2) to a frame of the machine, characterized in that it comprises at least one secondary member (5) whose elastic and/or surface properties are different from those of said main body (2), there being provided releasable connection means (6), for removably securing said at least one member (5) to said main body (2), so as to define said seat surface (3) therewith.

2. A structure as claimed in claim 1, characterized in that said main body (2) and said at least one secondary member (5) have respective upper surfaces (7, 8), reciprocally joined to make the seat surface (3) substantially continuous for the user's body.

3. A structure as claimed in claim 1, characterized in that it comprises a plurality of secondary members (5), removably securable to said main body (2) with said connection means (6).

4. A structure as claimed in claim 3, characterized in that said main body (2) comprises a housing (9, 9′) for each of said secondary members (5).

5. A structure as claimed in claim 4, characterized in that said connection means (6) are located at each of said housings (9, 9′)

6. A structure as claimed in claim 5, characterized in that said connection means (6) include a first portion (10) integral with said main body (2) for each of said housings (9, 9′) and a second portion (11) integral with the corresponding secondary member (5), for interacting with said first portion (10) to removably secure the corresponding secondary member (5).

7. A structure as claimed in claim 6, characterized in that said second portion (22) of said connection means (6) has a rigidity different from that of the corresponding member (5) integral therewith.

8. A structure as claimed in claim 6, characterized in that at least one of said housings (9) is formed internally of said main body (2).

9. A structure as claimed in claim 8, characterized in that said at least one inner housing (9) has an interface wall (13) that is substantially concave with the corresponding secondary member (5).

10. A structure as claimed in claim 8, characterized in that said at least one inner housing (9) has an interface wall (13) that is at least partially convex with the corresponding secondary member (5).

11. A structure as claimed in claim 9, characterized in that said first portion (10) of said connection means (6) has an edge (14) projecting out of said concave wall (13) for supporting the corresponding second portion (11) of the connection means (6).

12. A structure as claimed in claim 11, characterized in that said projecting edge (14) is provided within said main body (2) or is connected with a bottom wall (15) of the latter.

13. A structure as claimed in claim 12, characterized in that said at least one inner housing (9) has a lower opening (16) at the bottom wall (15) of said main body (2), to facilitate removal of the corresponding member (5).

14. A structure as claimed in claim 7, characterized in that at least one of said housings (9′) is provided at an outer peripheral edge (12) of said main body (2).

15. A structure as claimed in claim 14, characterized in that said at least one peripheral housing (9′) has an interface wall (13′) that is at least partially convex or plane with the corresponding member (5).

16. A structure as claimed in claim 15, characterized in that said first portion (10) of said connection means (6) has an extension (17) projecting out of said at least partially convex wall (13′) for engagement with the corresponding second portion (11) of the connection means (6).

17. A structure as claimed in claim 16, characterized in that said first (10) and second (11) portions at said at least one peripheral housing (9′) are covered by the corresponding member (5) or connected with a bottom wall (15) of the main body (2).

18. A structure as claimed in claim 3, characterized in that at least one of said elements (5) has portions with different rigidities.

19. A structure as claimed in claim 3, characterized in that the top surface (8) of at least one of said elements (5) has a surface roughness different from that of the top surface (7) of said main body (2).
